(19) United States
(12) Patent Application Publication
(10) Pub. No.: US 2022/0378667 A1
(43) Pub. Date: Dec. 1, 2022

(54) FEEDING ASSISTANCE DEVICE AND METHOD OF MANUFACTURING SAME

(71) Applicant: Bottapals, LLC, East Wenatchee, WA (US)

(72) Inventor: Stephannie L. Torres, East Wenatchee, WA (US)

(21) Appl. No.: 17/830,271

(22) Filed: Jun. 1, 2022

Related U.S. Application Data
(60) Provisional application No. 63/195,611, filed on Jun. 1, 2021.

(51) Int. Cl. A61J 17/00

(52) U.S. Cl. CPC A61J 17/001; A61J 17/1115; A61J 17/1011; A61J 17/1012

(57) ABSTRACT

A feeding assistance device and method for making same is disclosed. The feeding assistance device comprises a band and an amusement device secured to the band. The band comprises an external portion, an internal portion, and a securing platform. The amusement device comprises an upper end, a lower end, and a lowermost part located on the lower end of the amusement device. The band secures the feeding assistance device to a feeding device, such as a bottle, sippy cup, variation thereof, or combination thereof. The amusement device can be a plush toy, head of an animal, or other toy.

### CROSS-REFERENCE TO RELATED APPLICATIONS

This application claims benefit of Ser. No. 63/195,611 filed Jun. 1, 2021, with the same title, and is incorporated herein as if fully restated herein.

### FIELD OF THE DISCLOSURE

The present disclosure generally relates to feeding assistance devices, and methods for using the same to feed, comfort and stimulate infants and promote the development of hand-eye coordination, sight, and cognitive development in infants.

### BACKGROUND OF THE DISCLOSURE

Without limiting the disclosure, there is a particular desire to help infants and toddlers eat or drink from feeding devices that can comprise bottles, sippy cups, or training cups. Infants and toddlers have short attention spans and can be fussy or finicky eaters.

In the first twelve months of an infant's life, the infant's senses of sight, smell, hearing, touch and taste develop more quickly than at any other point of the infant's life. During this time, infants will develop a sense of curiosity in response to sensory stimuli. However, this sense of curiosity can make feeding difficult, because an infant's head may move or thrash in a plurality of directions while the infant finds an object to focus their attention on during feeding. This behavior can be further exacerbated if the infant has sensory issues. Sensory issues may comprise sensory modulation disorders, motor planning delays, sensory perceptual disorders, bilateral coordination delays, lack of sight abilities, variations thereof, or combinations thereof.

The feeding issues described above may prevent caretakers from feeding infants with one hand and may require constant attention from caretakers while feeding their infants. Failing to pay close attention to infants during feeding may cause the feeding device to fall from the infant's mouth on multiple occasions while a caretaker may feed an infant. This may cause the contents of the feeding device to spill onto the infant or caretaker and not be fed to the infant, toddler, or child. The caretaker may have to wash the feeding device before attempting to feed the infant again, which can increase frustration each time the feeding device falls from the infant's mouth. If an infant excessively moves throughout the feeding, excess air may enter the infant's stomach and may cause the infant to spit up, vomit, or have excessive gas.

There remains a need for calming infants and preventing movement of infants during meals. There is also a need to simultaneously promote healthy development of infants' sensory abilities, cognitive skills, and fine motor skills, even during feeding. The present disclosure provides solutions to the problems that infants, toddlers, children and caretakers face during mealtimes when using feeding devices.

Other desirable features and characteristics of the present disclosure will become apparent from the subsequent detailed description and claims, taken in conjunction with the accompanying drawings and this background of the disclosure.

### SUMMARY OF THE DISCLOSURE

Systems and methods directed to a feeding assistance device are disclosed.

The present disclosure is directed to an infant feeding assistance device. In one aspect, a band may comprise an external portion and an internal portion can be attached to an amusement device. The amusement device can comprise an upper end, a lower end and a lowermost part located on the lower end of the amusement device. A securing platform may comprise a top end and a bottom end that may join the band to the amusement device.

A method for manufacturing the feeding assistance device is disclosed. The method may comprise injection molding a band and a securing platform. The band may comprise an external face and an internal face. The securing platform may comprise a top end and a bottom end. A portion of the external face of the band can be fused to the bottom end of the securing platform. An amusement device may be removably secured to the top end of the securing platform.

In another aspect of the disclosure, the amusement device may comprise beads, beans, rice, liquid, gel, or other material inside the amusement device that can be heated, such as heading by microwave. The covering of the amusement device may be made from a material that can be microwaved for a short period of time without damaging the material. The beads, beans, rice, or other material may be held in a sac inside the amusement device that can be removed from the amusement device for heating. The entire amusement device may be heated without needing to heat the inner sac separately from the amusement device when any components of the amusement device that cannot be heated have been removed from, or are not present, in the internal cavity of the amusement device.

In another aspect of the disclosure, the amusement device may comprise a sac containing a material that can be frozen or cooled.

In another aspect of the disclosure, the amusement device may transfer heat to the feeding device to keep the contents inside the feeding device warm. The amusement device can be warmed to a temperature that will not burn an infant when an infant touches the amusement device. An infant may learn the feeling of warm when the infant touches the amusement device.

In another aspect of the disclosure, the amusement device may cool the contents inside the feeding device and help keep the contents inside the feeding device cool. An infant may touch the cooled amusement device and learn the feeling of touching something cool when the amusement device is cooled.

These and other objects, features and advantages of the present disclosure will become more readily apparent to a person skilled in the art from the following description, drawings, specifications and claims.

### BRIEF DESCRIPTION OF THE DRAWINGS

FIG. 1 is a top perspective view of an exemplary aspect of the feeding assistance device attached to an feeding device as described in the present disclosure;

FIG. 2 is a front view of an exemplary aspect of the feeding assistance device employed on a first exemplary type of an infant feeding device as described in the present disclosure;

FIG. 3 is a front view of an exemplary aspect of the feeding assistance device employed on a second exemplary type of an infant feeding device as described in the present disclosure;

FIG. 4 is a front view of an exemplary aspect of the band of the feeding assistance device as described in the present disclosure;

FIG. 5 is a front view of an exemplary aspect of the feeding assistance device as described in the present disclosure;

FIG. 6 is an isometric view of an exemplary aspect of a plurality of feeding assistance devices as described in the present disclosure;

FIG. 7 is a front view of an exemplary aspect of the securing platform being affixed to the outside of an amusement device as described in the present disclosure;

FIG. 8 is a rear view of an exemplary aspect of the securing platform being located inside an amusement device as described in the present disclosure;

FIG. 9 is a top perspective view of an exemplary aspect of a circuit board as described in the present disclosure;

FIG. 10 is an isometric view of an exemplary audio output device as described in the present disclosure;

FIG. 11 is an isometric view of an exemplary light emitting device as described in the present disclosure;

FIG. 12 is a front view of an exemplary aspect of the inner sac as described in the present disclosure;

FIG. 13 is a rear view of an exemplary aspect of an amusement device with the back of the amusement device open to view the circuitry, audio output, and light emitting device housed inside the amusement device of the feeding assistance device; and

FIG. 14 is a rear view of an exemplary aspect of an amusement device with the back of the amusement device open to view the stuffing and inner sac housed inside the amusement device of the feeding assistance device.

### DETAILED DESCRIPTION OF THE DRAWINGS

The invention is defined by the claims. The description is exemplary in nature and should not be used to limit the claims. Other embodiments are contemplated in accordance with the techniques described herein; such embodiments are within the scope of this application. Further, there is no intent to be bound by any expressed or implied theory presented in this application. The words “exemplary” or “illustrative” means “serving as an example, instance, or illustration.” Any implementations described as “exemplary” or “illustrative” are not to be construed as preferred or advantageous over other implementations. All the implementations described below are exemplary implementations, in order to enable people skilled in the art to make or use the disclosed embodiments and are not intended to limit the scope of the disclosure, which is defined by the claims.

Some features may be described using relative terms, such as terms “upper,” “lower,” “left,” “rear,” “right,” “front,” “vertical,” and “horizontal.” Such relative terms are only for reference with respect to the appended Figures and are not meant to limit the disclosed embodiments. Hence, specific dimensions and other physical characteristics relating to the embodiments disclosed herein are not to be considered as limiting, unless the claims expressly state otherwise.

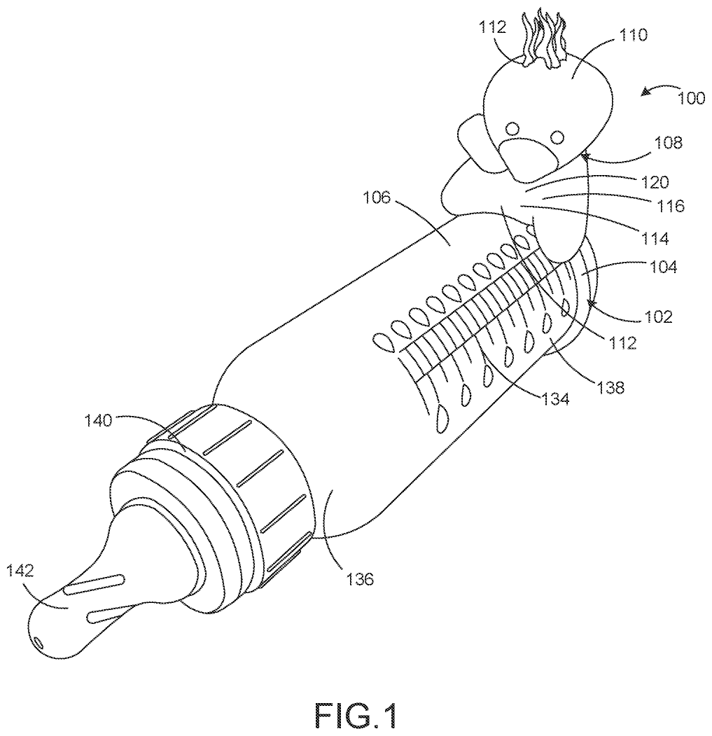

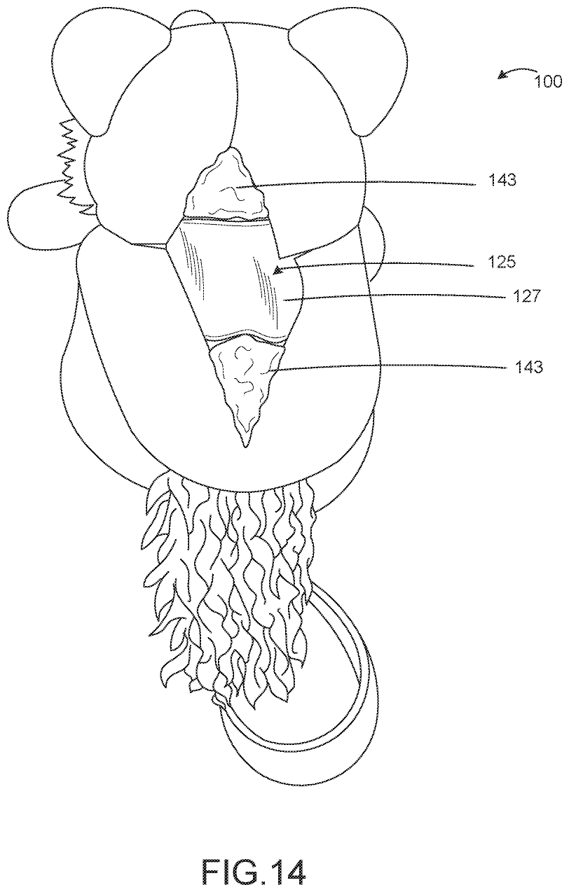

FIG. 1 illustrates a top perspective view of an exemplary aspect of the feeding assistance device 100. The feeding assistance device 100 may comprise a band 102. The band 102 may comprise an external portion 104 and an internal portion 106. The band 102 may be made of a material that may comprise silicone, rubber, plush, plastic, thermoplastics, elastic, variations thereof, or combinations thereof and may comprise a diameter of at least 2 inches and a maximum of 4 inches. The maximum diameter of 4 inches stops the band 102 from being able to be put over a baby's, infant's, or toddler's head or around the neck. An amusement device 108 may be secured to the band 102. The band 102 may be a fixed length. The band 102 may be adjustable. The band 102 may be stretchy or may be ridged. The amusement device 108 may comprise an upper end 110 that can further comprise an external part 112, an internal cavity 125 (see FIGS. 13 and 14), a lower end 114 that can further comprise an external part 116, and a lowermost part 118 that can be located on the lower end 114 of the amusement device 108. The internal cavity 125 (see FIGS. 13 and 14) of the amusement device 108 may be filled or stuffed with a material 143 comprising synthetic fiber, batting, cotton, straw, wood wool, plastic pellets, beans, rice, beads, variations thereof, or combinations thereof.

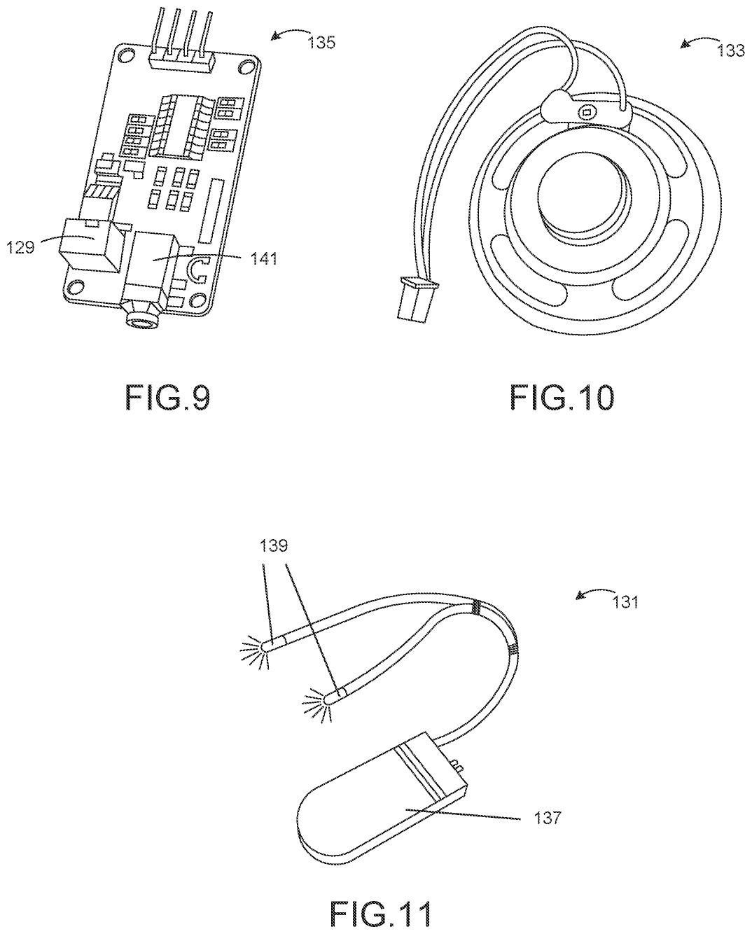

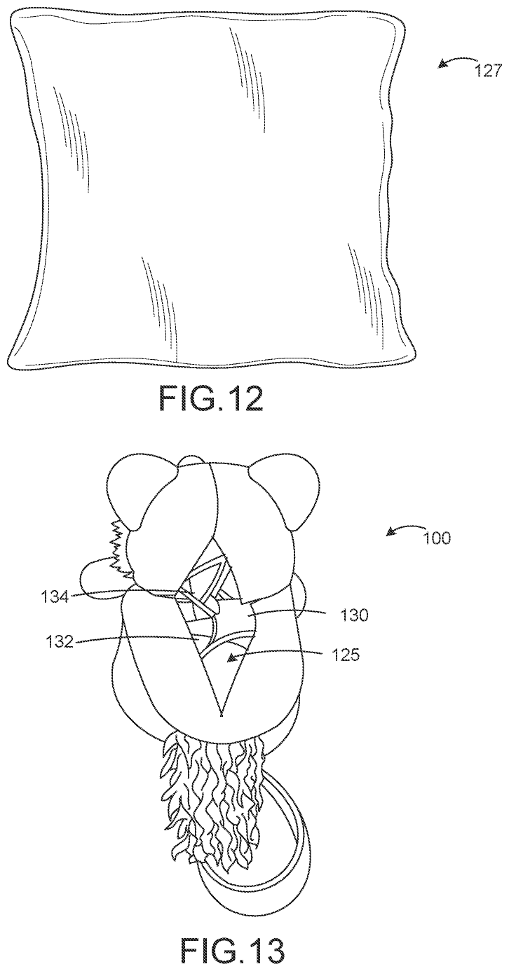

The amusement device 108 may comprise a length of at least one inch and may comprise a width of at least one inch. In some embodiments, and as shown in FIGS. 1-3 and 5, the amusement device 108 may comprise a body 120. The body 120 may be openable and comprise an inner sac 127 (see FIG. 12) that can be filled with beads, beans, rice, liquid, gel, variations thereof, or other materials that can be heated or cooled, or combinations thereof. The body 120 may comprise a zipper (not shown) or buttons (not shown) or snaps (not shown) or hook and loop closure (not shown) or magnets (not shown) or clips (not shown) for opening and closing the body 120 to remove and replace the inner sac 127 (see FIGS. 12 and 14), change the battery 129 (see FIG. 9), and/or to access any of the components housed inside the body 120 in the internal cavity 125 (see FIGS. 13 and 14). This disclosure is not intended to be limited by the type of fastener used to close an openable seam in the body 120 to access the internal cavity 125 of the amusement device 108. The inner sac 127 (see FIGS. 12 and 14) or amusement device 108 may be heated and the contents of the sac can transfer heat to the contents in a feeding device. The amusement device 108 may also be cooled and help keep the contents in a feeding device cool.

The amusement device 108 may be a toy, such as stuffed or plush toys, heads of animals, sporting equipment, such as soccer balls, basket balls, footballs, plants, flowers, food items, bugs, fictional characters, variations thereof, or combinations thereof. The amusement device 108 is not intended to be limited to one type of stuffed or plush toy shape by this disclosure and may comprise a rattle or a portion that makes sounds. The amusement device 108 may comprise a mirror. The inner sac 127 of the amusement device 108 may comprise a scented portion or pouch to aid in the development of an infant's, child's, or toddler's olfactory sense. The scent portion of the inner sac 127 may comprise aromatherapy scents to help settle a restless infant, toddler, or child, relieve pain from teething or sickness, and provide any or all benefits to an infant, toddler, or child that aromatherapy offers. The scent portion of the inner sac 127 may be replaced or refilled with scent.

The amusement device 108 may be made from a combination of materials that allow an infant to experience different tactile sensations and aid in developing tactile senses when touching the amusement device. The amusement device 108 may comprise a light emitting device 131 (see FIG. 11), an audio output device 133 (see FIG. 10), an on/off switch (not shown), and may be powered by a battery 129 (see FIG. 9) that can be recharged by plugging in the feeding assistance device 100 to a wall outlet, USB charger, or the like. The battery 129 (see FIG. 9) may be a replaceable battery.

The light emitting device 131 may comprise a lighting control unit 137 that allows the lights 139 to twinkle, turn on and off intermittently or in a pattern, or may light up in concert with sound being outputted by the audio output device 133 (see FIG. 10). The lights 139 can be LED lights. The sound emitted from the audio output device 133 may be a song, the voice of the infant's, toddler's, or child's family member, a musical beat, a heartbeat sound, an animal sound, or any other sound that would entertain an infant, toddler, or child and aid in developing the infant's, toddler's, or child's auditory sense. The amusement device 108 may comprise a means for recording audio, such as a microphone, storing audio, such as a memory device, and playing back the stored audio.

The band 102 may be removably secured to a feeding device 134. An internal portion 106 of the band 102 can contact the outside of the feeding device and the band 102 can be secured to the feeding device 134 by using friction and pressure forces. The feeding device 134 may comprise a top end 136 and a bottom end 138. A lid 140 may be removably secured to the top end 136 of the feeding device 134. A sipping protrusion 142 may be located on an uppermost portion of the lid 140. The sipping protrusion 142 allows a user to drink the contents housed inside the feeding device 134. The amusement device 108 can be seen and touched by a user, such as a infant, toddler, or child, as the user is feeding from the feeding device 134. The amusement device 108 can stimulate infants' senses, such as sight, sound, auditory, and touch, and can help the infant, toddler, or child, to stay interested and focused on feeding while feeding from the feeding device 134.

In some aspects of the present disclosure, the internal portion 106 of the band 102 may be removably secured to the bottom end 138 of the feeding device 134. In other aspects of the present disclosure, the internal portion 106 of the band 102 may be removably secured along a body of the feeding device 134. The feeding device 134 may be a liquid container, such as a bottle, sippy cup, variations thereof, or combinations thereof.

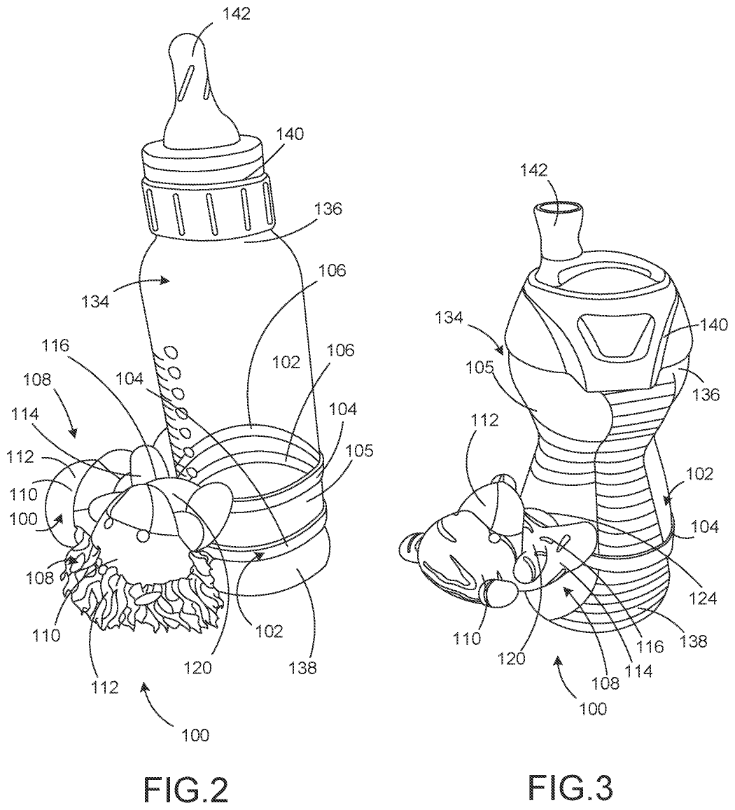

FIGS. 2 and 3 illustrate a front view of the feeding assistance device 100 employed on two different feeding devices 134. Each of the feeding assistance devices 100 may comprise the band 102. As illustrated in FIG. 1, multiple feeding assistance devices 100 can be employed on one feeding device 134. The band 102 may comprise the external portion 104 and the internal portion 106. At least one amusement device 108 may be secured to the band 102. The amusement devices 108 may comprise the upper end 110 that can further comprise the external part 112, the internal cavity 125 (see FIGS. 13 and 14), the lower end 114 that can further comprise the external part 116, and the lowermost part 118 that can be located on the lower end 114 of each of the amusement devices 108. In some embodiments, and as shown in FIGS. 1-3 and 5, each of the amusement devices 108 may comprise the body 120. The lowermost part 118 of the amusement device 108 may be joined to a top end 124 of a securing platform 122.

The securing platform 122 can be located on the external part 112 of the band 102 and engage the external part 112 of the lowermost part 118 of the amusement device 108. The securing platform 122 can also be inserted into the body 120 of the amusement device 108 (see FIG. 5). The securing platform 122 may be a flat area on the band 102 or may be a joint between ends of the band 102 and the inside of the body 120. The securing platform 122 can connect either the external part 116 of the lower end 114 of the amusement device 108 to the band 102 or the inside of the lower end 114 of the amusement device 108 to the band 102. The securing platform 122 may permanently engage the band 102 to the amusement device 108 or the amusement device 108 may be removably engaged to the band 102. The lowermost part of each of the amusement devices 108 may be joined to each of the top ends 124 of each of the securing platforms by using a fastener or an adhesive such as glue, hot glue, fabric glue, stitching, snap, hook and loop, button, magnets, zipper variations thereof, or combinations thereof. This disclosure is not intended to be limited to a specific type of fastener or adhesive used to attach the band 102 to the amusement device 108. The lowermost part 118 of the amusement device 108 can be removably joined to the top ends 124 of the securing platforms by using a fastener, such as a snap or a button. The amusement device 108 of the feeding assistance device 100 can be interchangeable.

A bottom end 126 of the securing platform 122, shown below in FIG. 7, may be permanently fused to, or formed as one continuous piece with, the external portion 104 of the band 102 through a process comprising gluing, solvent bonding, adhesion bonding, sewing, variations thereof, or combinations thereof. The securing platform 122 affixes the band 102 to the amusement device 108. The securing platform 122 may be made from material comprising silicone, rubber, plush, plastic, compostable plastics, biodegradable plastics, plant-based materials that are flexible and rigid, thermoplastics, variations thereof, or combinations thereof and may have a length and a width less than the length and the width of the lower end 114 of the amusement device 108. This disclosure is not intended to be limited by the specific type of material used to make the band 102.

The internal portion 106 of the band 102 may be slid around an outside surface 105 of the feeding device 134. More than one feeding assistance device 100 may be employed.

In FIG. 3, the LED lights 139 are shown as on and/or blinking in the eyes of the amusement device 108.

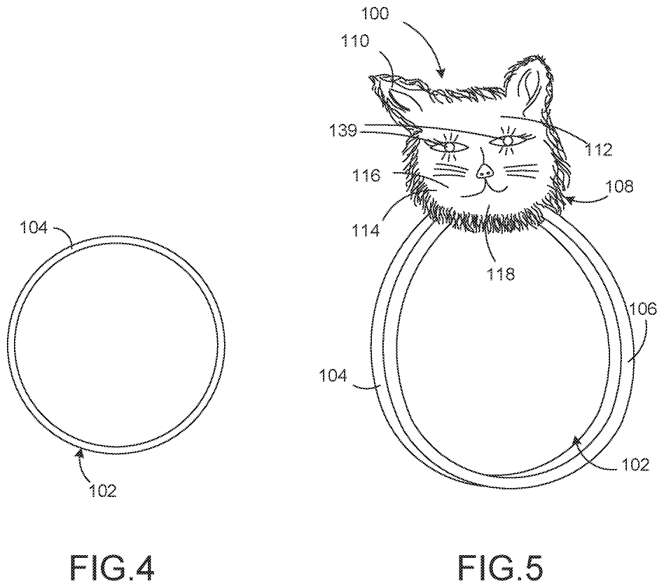

FIG. 4 illustrates a front view of an exemplary aspect of the band 102. Each of the feeding assistant devices 100 may comprise the band 102. The bands 102 may comprise the external portion 104 and the internal portion 106.

Turning to FIG. 5, a front view of an exemplary aspect of a feeding assistant device 100 is illustrated. The securing platform 122 is housed inside the amusement device 108. The amusement devices 108 may comprise the upper end 110, the external part 112, the internal cavity 125 (see FIGS. 13 and 14), the lower end 114 that can further comprise the external part 116, and the lowermost part 118 that can be located on the lower end 114 of each of the amusement devices 108.

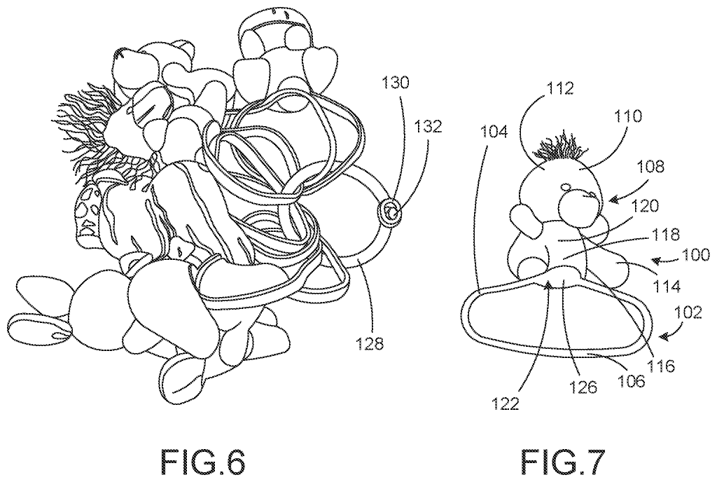

FIG. 6 illustrates an isometric view of a plurality of feeding assistance devices 100 secured to a ring 128 for organizing and carrying the feeding assistance devices 100. The ring 128 can comprise a clasp 130.

In some embodiments, and as shown in FIGS. 1-2 above and FIG. 4, each of the amusement devices 108 may comprise the body 120. The lowermost part 118 of each of the amusement devices 108 may be joined to the top end 124 of the securing platform 122 that can be located on each of the external portions 104 of each of the bands 102. Each of the bottom ends 126 of the securing platform 122 may be fused to each of the external portions 104 of each of the bands 102 through a process comprising gluing, solvent bonding, adhesion bonding, variations thereof, or combinations thereof. Each of the securing platforms 122 may enable each of the amusement devices 108 to affix to each of the bands 102.

At least one feeding assistance device 100 may be removably held by a ring 128. The ring 128 may comprise a clasp 130 and a protrusion 132. The clasp 130 may maintain a shape of the ring 128. The shape of the ring 128 may be circular, elliptical, oblong, ovoid, egg-shaped, variations thereof, or combinations thereof. The clasp 130 may be lifted in order to disassemble the ring 128 into components, not shown, and remove at least one feeding assistance device 100. The clasp 130 may be lowered when the components, not shown, of the ring 128 are joined in order to assemble the ring 128. The protrusion 132 may secure the clasp 130 to the ring 128 and may assist the clasp 130 in maintaining the shape of the ring 128. The ring 128 may be held by a user's vehicle, belt, table, keyring, highchair, purse, garment bag, suitcase, backpack, variations thereof, and combinations thereof. The ring 128 may be made from a washable material comprising silicone, rubber, plush, plastic, thermoplastics, variations thereof, or combinations thereof. The ring may comprise a diameter of at least 5 inches. Each of the feeding assistance devices 100 can be made of a washable material comprising silicone, rubber, plush, plastic, thermoplastics, variations thereof, or combinations thereof.

Turning to FIG. 7, an aspect of the securing platform 122 securing the band 102 to the external part 112 of the amusement device 108 to is illustrated.

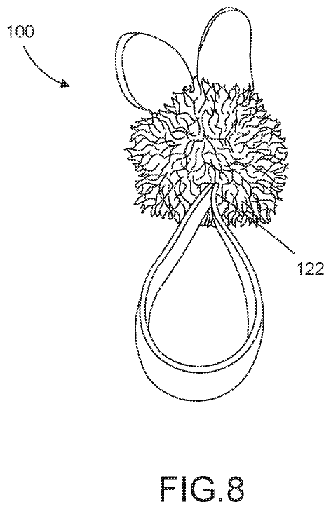

Turning to FIG. 8, a rear view of an exemplary aspect of the feeding assistance device 100 is illustrated showing the securing platform 122 securing the band 102 to the inside of the amusement device 108 is illustrated.

Turning to FIG. 9, an exemplary aspect of a circuit board 135 is illustrated. The circuit board 135 can comprise a battery 129, capacitors, resistors, diodes audio output connector, microphone connector, and other standard components for a circuit board for use with audio output devices, light emitting devices, audio input devices, and synchronizing audio output with the lights turning on and off. The circuit board 135 can be a printed circuit board. The circuit board can be connected to a power switch (not shown). The power switch can be located in the amusement device 108 and the amusement device 108 can be squeezed, e.g., squeezing an ear, nose, cheek, or other portion of the amusement device 108 (though the amusement device does not need to comprise an ear, nose, or cheek), to turn the power switch on and/or off.

Turning to FIG. 10, an exemplary aspect of an audio output device 133 is illustrated. The audio output device 133 can connect to the circuit board 135 via audio connector 141.

Turning to FIG. 11, an exemplary aspect of a light emitting device 131 is illustrated. The light emitting device 131 comprises a lighting control unit 137 and at least two led lights 139. The light control unit can connect to the circuit board 135.

Turning to FIG. 12, an exemplary aspect of the inner sac 127 is illustrated. While the inner sac 127 is shown as being square-shaped, this disclosure is not intended to be limited to the shape of the inner sac 127. The inner sac 127 can be made of fabric and comprise a lining and a zipper or other means for accessing the inside of the inner sac 127 and opening and closing the inner sac 127. The inner sac 127 can be placed in the internal cavity 125 of the amusement device. The inner sac 127 can comprise contents that can be heated or cooled. Scents and fragrances can be added to the inner sac 127 and replenished as the scents and fragrances dissipate.

Turning to FIG. 13, an exemplary aspect of the feeding assistance device 100 is illustrated showing the rear of the amusement device 108 open and exposing the circuit board 135, audio output device 133, and light emitting device 131 house in the internal cavity 125 of the amusement device.

Turning to FIG. 14, an exemplary aspect of the feeding assistance device 100 is illustrated showing the rear of the amusement device 108 open an exposing the material 143 and inner sac 127 housed in the internal cavity 125.

Sensory and motor development is the gradual process by which a child gains use and coordination of the large muscles of the legs, trunk, and arms, and the smaller muscles of the hands. A baby begins to experience new awareness through sight, touch, taste, smell, and hearing.

The feeding assistance device 100 can help an infant, toddler, or child develop his or her cognitive skills, motor skills, sight, sound, touch, and more. Infants can only see shapes when first born and need to develop sight skills. Infants' motor development generally follows a typical pattern:

At 1 month of age, babies' neck muscles are not developed enough to support their heads for prolonged periods of time. Babies can lift their heads only briefly when lying on their stomachs. Limb movements are influenced by newborn reflexes, such as the startle reflex, which makes a baby throw out his or her arms and spread the fingers in response to a loud noise or other sudden, unexpected stimulus. By 6 weeks of age, newborn reflexes begin to fade and the baby's strength and coordination improve.

By age 3 months, your baby can control his or her head movements. The baby can be placed his or her tummy, in a prone position, during awake periods. Allowing your baby to exercise and move in this position helps develop head and neck muscles. Around 4 months of age, babies gain control and balance in their head, neck, and trunk. Most babies can balance their heads for short periods when in a stable position. Around this same age, your baby starts playing with his or her hands and grasps your finger on purpose, rather than as a reflex.

Between 4 and 6 months of age, babies' balance and movement dramatically improve as they gain use and coordination of large muscles. During this time, babies purposefully roll over and may be able to sit with their hands balancing them in front (tripod position). Reaching toward an object with both hands, babies may grasp at toys with their palms.

Babies gain more control of their muscles between 6 and 9 months of age as the nervous system connections continue to form. By the 7th month, babies can see almost as well as an adult. Babies develop leg and trunk coordination, sit alone steadily, and may crawl using both their hands and feet. Some babies even pull themselves up to a standing position, although the timing and sequence of these milestones vary widely.

Around 9 to 12 months of age, babies develop more control over their hands and fingers and may be able to grab small objects with a forefinger and thumb. The brain continues to grow, helping to refine control over the large muscles. A baby should be able to crawl and stand at this age. Before babies begin to walk, they often spend hours “cruising” around the room holding on to furniture and other objects. Cruising develops muscles and coordination and allows a baby to practice walking.

Many toddlers start to walk around 9 to 15 months old. A baby's brain and the spinal cord have developed and changed enough to allow the baby to walk.

Infants' sensory development generally follows a typical pattern:

Vision. At 1 month of age, babies can see about 30 cm (12 in.) in front of them. Babies this age especially enjoy looking at the human face and bright contrasting colors. At 2 months of age, babies begin to be able to follow a toy or other object when it is moved in front of their face. At 3 to 4 months, babies can focus on an object or your smiling face from 1 m (1.1 yd) to 2 m (2.2 yd) away and begin to see a full range of colors. At 7 to 12 months, a baby's vision is the same as an adult's vision.

Hearing. At 1 month of age, babies strongly prefer the sound of the human voice. Hearing is the same as an adult's hearing. They recognize the voice of their caregiver, even when they are in another room. At 2 months of age, babies begin to coo and make sounds, such as ooh and ahh. At 4 months, babies often amuse themselves with babbling and are beginning to understand that tone of voice means different things. At 6 or 7 months, babies start copying the sounds they hear spoken. Babies may not be able to say the words they are hearing yet, but they can understand many of the words you say. At 12 months, babies are working hard to master language, and soon they may say their first word.

Touch. Babies of all ages have a well-developed sense of touch. They often prefer soft, gentle touches and cuddles.

Smell and taste. Babies of all ages have a well-developed sense of smell and taste. They prefer sweet smells and know the smell of their mother's breast milk. At 9 to 12 months of age, most babies like to experience and explore objects through taste and texture, which prompts them to put almost anything they can into their mouths.

The feeding assistance device 100 can allow an infant, toddler, or child to develop all of the above by allowing the infant, toddler, or child to see, touch, and/or hear the infant feeding aid while the infant, toddler, or child is feeding.

Since many modifications, variations, and changes in detail can be made to the described preferred embodiments of the invention, it is intended that all matters in the foregoing description and shown in the accompanying drawings be interpreted as illustrative and not in a limiting sense.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above.

For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

In some embodiments, the feeding assistance device 100 may comprise a printed circuit board, wiring, a control module, and programming, to allow the lights and audio output device to operate. Wiring of such electronics is known.

Although some, and maybe preferred, embodiments of the disclosure have been described in detail herein, those skilled in the art will recognize that various substitutions and modifications may be made without departing from the scope and spirit of the appended claims. Thus, the scope of the invention should be determined by the appended claims and their legal equivalents.

What is claimed is:

1. A feeding assistance device comprising:
a band comprising an external portion, an internal portion, and a securing platform; and
an amusement device comprising an internal cavity, an upper end, a lower end, and a lowermost part located on the lower end of the amusement device, wherein the securing platform joins the band to the amusement device.

2. The feeding assistance device of claim 1, wherein the internal portion of the band contacts an outer surface of a feeding device and removably affixes the feeding assistance device to the feeding device.

3. The feeding assistance device of claim 1, further comprising an inner sac housed in the inside cavity of the amusement device, wherein the inner sac houses beads, beans, rice, liquid, gel, or combinations thereof that can be heated or cooled.

4. The feeding assistance device of claim 1, wherein the band is made of a material comprising silicone, rubber, plush, plastic, thermoplastics, biodegradable plastics, compostable plastics, plant-based materials, variations thereof, or combinations thereof.

5. The feeding assistance device of claim 1, wherein the band has a diameter of at least two inches.

6. The feeding assistance device of claim 1, wherein the internal cavity of the amusement device is filled with a material comprising synthetic fiber, batting, cotton, straw, wood, wool, plastic pellets, beans, beads, rice, liquid, gel, variations thereof, or combinations thereof.

7. The feeding assistance device of claim 1, wherein the feeding assistance device is made of a washable material comprising at least one of silicone, rubber, plush, plastic, biodegradable plastic, compostable plastic, plant-based materials, thermoplastics, variations thereof, or combinations thereof.

8. The feeding assistance device of claim 1, further comprising a circuit board and an audio output device.

9. The feeding assistance device of claim 1, wherein the securing platform joins the lowermost part of the amusement device to the band.

10. The feeding assistance device of claim 1, wherein the band is adjustable in size.

11. The feeding assistance device of claim 1, further comprising an on/off switch and at least one light emitting device.

12. The feeding assistance device of claim 11, further comprising an audio output device, wherein the light emitting device turns on and off in a pattern synchronized to audio outputted by the audio output device.

13. The feeding assistance device of claim 1, further comprising a scent incorporated into the amusement device.

14. A method for manufacturing a feeding assistance device, the method comprising:
molding a band comprising an external face and an internal face and a securing platform;
fusing a portion of the external face of the band to the securing platform; and
joining an amusement device to the securing platform, wherein the amusement device comprises an external portion, an internal cavity, wherein the internal cavity can be accessed through the external portion.

15. The method of claim 14, wherein the band comprises a diameter of at least two inches.

16. The method of claim 14, wherein a lowermost end of the amusement device is located on a lower end of the amusement device and is joined to the securing platform.

17. The method of claim 14, further comprising molding the band by injection molding.

18. The method of claim 14, further comprising infusing the amusement device with a scent.

19. The method of claim 14, further comprising forming an openable seam on the amusement device for accessing the internal cavity of the amusement device, wherein the openable seam can be closed and reopened.

20. The method of claim 15, further comprising inserting a battery, circuitry, wiring, microphone, and audio output device in the internal cavity of the amusement device.
